(19) United States
(12) Patent Application Publication
(10) Pub. No.: US 2009/0287574 A1
(43) Pub. Date: Nov. 19, 2009

(54) ATTACHMENT OF VIDEOS TO ADVERTISEMENTS ON WEBSITES

(76) Inventor: Brendan Kane, Los Angeles, CA (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/121,893

(22) Filed: May 16, 2008

(51) Int. Cl. G06Q 30/00

(52) U.S. Cl. 705/14.73

(57) ABSTRACT

An advertisement is provided as an element of a personal space of a user. A video is added to the advertisement. The video is played in relation to the advertisement. The personal space, for example, may be a personal web page, which may be hosted by a social networking provider.

### RELATED APPLICATIONS

The present application discloses subject matter similar to that disclosed in U.S. application Ser. No. 11/696,499 filed on Apr. 4, 2007.

### TECHNICAL FIELD

Individual users are given the ability to choose which advertisements they want to place on their personal web pages, instant messages, and/or the like, and to attach videos to the advertisements so that, when visitors select the advertisements, the videos will play.

### BACKGROUND

Social networking websites permit individual users to create their own personal web pages that they can decorate and otherwise arrange according to their personal tastes and that they can permit visitors to access. Those who operate social networking websites continue to seek ways in which to profit from the social networking phenomenon. Thus, social networking website operators are looking for ways to create viable business models, to integrate new forms of advertising and transactions, and to make a profit.

Generally, in terms of generating revenue, those who engage in business-to-consumer e-commerce fall into two possibly overlapping groups, those who collect revenue from selling products, services and/or subscriptions, and those who provide content, subscriptions, and/or services in order to sell advertising. The majority of social networking websites are not cleanly in either group because their core business model is consumer to consumer; and they have had trouble generating revenue due to the fact that they are not charging subscription fees for their services.

Most of these networking websites provide a free service by allowing individual users to create their own personal web pages over the Internet, providing these individual users with a sense of ownership. This service raises the critical question as to whether it is right to place advertisements on the personal web pages of individual users without their consent, and even an advertisements are placed on their personal web pages without their consent, there is the question of how effective the advertisements will be if they are not endorsed or at least accepted by the individual users who create the personal web pages. Thus far it has only been banner ads and other standard forms of advertising that have made it onto these personal web pages, which has been proven ineffective by the low CPM rates they generate. The answer to this question is not only about what is right and wrong, but also about whether the millions of individual users using these networking websites will allow others to exploit them and make money off of their personal creations.

As social networking websites grow, one of their main objectives is to generate profit. In order to generate profit, these websites have bombarded not only their own web pages with banner ads and other standard forms of advertising but also the personal web pages of the individual users of the social networking websites. These banner ads and other standard forms of advertising advertise goods and/or services, include text and/or graphics, and usually include a hot link to the website of the advertiser.

Many social networking websites fail to understand that their individual users are the reason that these communities have become so successful. Indeed, individual users alone determine the future success of this type of business. Therefore, it is not in the best interests of the owners of social networking websites to place advertisements on personal web pages of individual users in order to generate revenue, unless the individual users are allowed to participate in the process. Such participation could be difficult to obtain if the individual users do not connect with the particular advertisements chosen by the social network to be placed on their pages and do not benefit from the advertisements as do the social network operators.

The great majority of personal web pages created by individual users on social networking websites contain free media advertising. A media advertisement is defined herein and for purposes of claim interpretation as video, where the video itself is the advertisement, as audio, where the audio itself is the advertisement, as music, where the music itself is the advertisement, as pictures, where pictures themselves are the advertisement, as posters, where the posters themselves are advertisement, as graphics, where graphics themselves are the advertisement, as wallpapers, where the wallpapers themselves are the advertisement, as logos, where the logos themselves are the advertisement, as animations, where the animations themselves are the advertisement, as film capture pictures, where film capture pictures themselves are the advertisement, and/or as games, where the games themselves are the advertisement. A media advertisement does not include standard internet advertising media units such as: banner ads, text only ads, tower ads, skyscraper ads, pop ups, and pop unders. Media advertisements tend to be decorative and, therefore, they tend to appeal aesthetically to the individual users, as well as to their interests and personalities.

Individual users fill their social networking personal web pages with music videos, movies, movie posters, CD covers, pictures of their favorite actors, cartoon characters, television commercials, and even include their favorite songs playing in the background. Not one of the movie studios, record labels, car companies, etc., pays for these prime advertising slots. Instead of allowing these advertisements without charge, revenues can be derived from the placement of these advertisements on the personal web pages of the individual users of social networking websites.

As an inducement to individual users to place and carry media advertisements on their personal web pages, revenues, whether cash or non-cash, derived from advertisers can be shared with the individual users for placing these advertisements on their personal web pages. Advertising revenues can also be shared with the operators of the social networking websites and can be accomplished without substantial change in the current social networking communities. Revenue derivation and/or sharing can be practiced with no noticeable change in the look or operation of these social networking websites.

The present invention relates to attaching videos to the advertisements, instant messages, or the like so that, when visitors select the advertisements, instant messages, or the like, the videos will play.

### BRIEF SUMMARY

According to one aspect of the present invention, a method performed by a web accessible computer comprises the following: providing a plurality of media advertisements of one or more first parties through the web accessible computer operated by a second party; electronically receiving a request from a third party in which the third party chooses at least one of the media advertisements to associate with a personal space of the third party, wherein the first, second, and third parties are separate parties; and, offering a payment to the third party relative to the chosen media advertisement.

According to another aspect of the present invention, a method performed by a web accessible computer of a first party comprises the following: electronically accessing a website operated by a second party, wherein the website operated by the second party provides a plurality of media advertisements of one or more third parties, wherein the first, second, and third parties are separate parties; electronically choosing at least one of the media advertisements for association with a personal space of the first party; and, electronically viewing information regarding payment to be made to the first party relating to the chosen media advertisement.

According to still another aspect of the present invention, a method performed by a web accessible computer of a first party comprises the following: electronically accessing a website operated by a second party for multiple media advertisements, wherein the multiple media advertisements are assigned to content so as to permit selected viewing of the media advertisements, and wherein the first and second parties are separate parties; electronically choosing to have the content with the multiple media advertisements associated with a personal space of the first party; and, electronically viewing information regarding payment to be made to the first party relating to at least one of the multiple media advertisements associated with the personal space.

According to yet another aspect of the present invention, a method performed by a web accessible computer comprises the following: electronically providing multiple media advertisements of one or more first parties through the web accessible computer operated by a second party, wherein the multiple media advertisements are assigned to content so as to permit selected viewing of the media advertisements; electronically receiving a request from a third party in which the third party chooses to have the content with the multiple media advertisements associated with a personal space of the third party, wherein the first, second, and third parties are separate parties; and, electronically offering a payment to the third party relative to at least one of the multiple media advertisements associated with the personal space.

According to a further aspect of the present invention, a method performed by a web accessible computer of a first party comprises the following: electronically accessing a website operated by a second party, wherein the website operated by the second party provides a plurality of media advertisements of one or more third parties, wherein the first, second, and third parties are separate parties; electronically choosing which of the media advertisements to associate with an instant message of the first party; and, electronically viewing information regarding payment to be made to the first party relative to the chosen media advertisement.

According to still a further aspect of the present invention, a method performed by a web accessible computer comprises the following: electronically providing a plurality of media advertisements of one or more first parties through the web accessible computer operated by a second party; electronically receiving a request from a third party in which the third party chooses at least one of the media advertisements to associate with instant message of the third party, wherein the first, second, and third parties are separate parties; and, electronically displaying information concerning a payment to be made to the third party relative to the chosen media advertisement associated with the instant message of the third party.

### BRIEF DESCRIPTION OF THE DRAWING

These and other features and advantages will become more apparent from the detailed description below when taken in conjunction with the drawings in which:

FIG. 1 is a block diagram useful in explaining various embodiments of the present invention;

FIGS. 2, 3, 4, 5, 6A, 6B, and 7 illustrate a flow chart representing the operations of an intermediary website or a website in the social networking or instant messaging communities in order to implement various embodiments of the present invention;

FIG. 8 illustrate a flow chart representing operations of individual users in order to implement various embodiments of the present invention;

FIGS. 9-12 illustrate the association of a video with an advertisement; and,

FIGS. 13 and 14 illustrate flow charts representing operations of an individual user for adding videos to advertisements and for playing those videos.

### DETAILED DESCRIPTION

One example of a way to derive revenue from the placement of media advertisements on personal web pages hosted by social networking websites is to create an intermediary website. As shown in FIG. 1, an intermediary website 10, an advertiser 12, an individual user 14, and a user support website 16 are interconnected by a communications medium 18 such as the Internet. Accordingly, each of the intermediary website 10, the advertiser 12, the individual user 14, and the user support website 16 will be understood to include one or more computers having access to the communications medium 18.

As described below, the user support website 16 may be a social networking website, in which case the personal web page is a social networking personal web page. Alternatively, the user support website 16 may be a blog website, in which case the personal web page is a blog personal web page.

As a further alternative, the user support website 16 may be an instant messaging website and/or service, in which case the media advertisement may be associated with instant messages. For example, most instant messaging services allow Buddy Icons (alternatively referred to as Avatars by some), which are small pieces of media such as pictures, graphics, small posters, etc., to be attached to instant messages that are then sent to others. The intermediary website 10, whose functions are implemented by a separate site and/or by the user support website 16, would act as a host for buddy icon media advertisements that are provided by the advertiser 12 and that the advertiser 12 is willing to pay for placement on the instant messages of the individual user 14.

The individual user 14 who uses instant messaging services can then choose the buddy icon at the intermediary site 10 for placement on the user's instant messages. In return, the individual user 14 will be compensated for the placement of the selected buddy icon on the user's instant messages.

Other alternatives are possible.

The advertiser 12 causes the intermediary website 10 to be loaded with media advertisements that it is willing to pay to have placed on the personal web pages or instant messages of the individual user 14 operating with the support of the user support website 16. For this purpose, the advertiser 12 can electronically upload these media advertisements to the intermediary website 10 over the communications medium 18. Alternatively, the advertiser 12 can send these media advertisements on disk or other storage media to the intermediary website 10 for storing on the intermediary website 10.

The individual user 14, as desired, accesses the intermediary site 10 and selects any offered media advertisements that the individual user 14 wishes to place on the user's personal web page or instant message that is supported by the user support website 16. The individual user 14 then incorporates the selected media advertisement into the user's personal web page and/or instant message and, in return, can receive payment for having the selected media advertisement on this personal web page and/or instant message.

As one possible condition for the advertiser 12 to participate in the placement of media advertisements at the intermediary website 10, the advertiser can be required to qualify for an account with the intermediary website 10. The intermediary website 10 in this example determines whether the advertiser 12 qualifies for an account. Once the intermediary website 10 qualifies the advertiser 12, an account is created, and the advertiser 12 is then able to create campaigns for its various advertisements.

When creating a campaign, the intermediary website 10 is capable of offering the advertiser 12 a series of choices. For example, one such choice might be the budget for the entire campaign. This budget could be the total amount of money that the advertiser 12 wants to spend in order to have its media advertisements placed on the personal web page and/or instant message of the individual user 14.

The entire budget could be paid to the intermediary website 10 up front before the campaign begins. Alternatively, the budget could be paid out on a use, time, or per activity basis each time a revenue generating activity occurs with respect to one of its media advertisements displayed on the personal web page and/or instant message of the individual user 14.

The revenues are distributed among up to three different parties: the intermediary website 10 keeps a percentage as a service fee, the user support website 16 is paid a percentage as a service fee, and/or the individual user 14 displaying the media advertisement on a corresponding social network web page or instant messages earns a percentage and/or some other form of payment (e.g. points, prizes) based on a payment model selected for that specific campaign or media advertisement.

The programming of the intermediary website 10 allows the intermediary website 10 to select and/or change the percentage paid to the user support website 16, the percentage paid and/or the amount of other form of payment to the individual user 14, and the percentage that the intermediary website 10 keeps for itself for each campaign.

When the advertiser 12 sets up a campaign, the intermediary website 10 has the ability to allow the advertiser 12 to choose a payment plan for each media advertisement within the particular campaign. Alternatively, the intermediary website 10 can choose the payment plan for the advertiser 12. Examples of the types of payment plans that can be offered to the advertiser 12 include (i) cost-per-click (CPC), (ii) cost-per-play (CPP) where a visitor to the personal web page of the individual user 14 has to view play the media advertisement (this view can be generated by both auto-play and non-auto-play players; which player is used can be determined by either the intermediary website 10 or the advertiser 12), (iii) cost-per-thousand impressions (CPM), (iv) cost-per-unique impression (CPUI), (v) cost-per-action (CPA), (vi) flat rate, etc. All of these payment forms are explained below.

Along with choosing the payment plan, the advertiser 12 enters the total budget it wishes to spend on the campaign. Once the budget has been completely used up, the media advertisements for that campaign will be deactivated by the intermediary website 10 and the advertiser 12 will no longer pay to have its media advertisements on the personal web page and/or instant message of the individual user 14. The individual user 14 can choose to continue to display the deactivated media advertisement, or to take the deactivated media advertisement off of the user's personal web page and/or instant message, and/or to select a new media advertisement from the intermediary website 10.

Once the advertiser 12 has finished making all of these choices and has paid the budget in full or has agreed to pay when necessary, its campaign will be activated and its media advertisements will appear on the intermediary website 10 for access by the individual user 14.

The individual user 14 may visit the intermediary website 10 and browse the available media advertisements. During browsing, the individual user 14 can play the media advertisements such as watching a video, listening to a song, viewing an image, playing a game, and so on. Supplemental materials, such as descriptions of products and/or services, can also be made available to the individual user 14.

In order for the individual user 14 to participate in the media advertisement program, the individual user 14 is required to sign up for an account. Thereafter, the individual user 14 logs onto the intermediary website 10. Once logged on, the individual user 14 is provided with additional information about the media advertisements. This information includes, for example, the amount that will be paid for a particular media advertisement, the type of payment plan that has been offered by the advertiser 12 for a particular advertisement, and a percentage-left statistic that indicates relative amount of the budget that remains to be used for each media advertisement.

The individual user 14 only sees the amount of money the individual user 14 is actually receiving. The individual user 14 does not see the total amount that the advertiser 12 is paying to have the media advertisement placed on personal web pages. For example, the individual user 14 does not see the service charges paid to the user support website 16 or to the intermediary website 10.

The percentage-left statistic shows the individual user 14 how much of a specific payment model is left in the campaign of the advertiser 12. For example, the cost-per-click campaign will have a percent of click-throughs left, which informs the individual user 14 of the percentage of payable clicks that is left for that particular media advertisement. There is also a percentage-left statistic for both forms (auto-play and non auto-play) of cost-per-play (CPP) that informs the individual user 14 of how many payable plays are left, for cost-per-thousand impressions (CPM) that informs the individual user 14 of how many payable blocks of 1,000 are left, for cost-per-unique impression (CPUI) that informs the individual user 14 of how many payable unique impressions are left, and for the flat rate campaigns that informs the individual user 14 of how many actual flat rate campaigns are left. This percentage-left statistic acts as one gauge that provides the individual user 14 with an indication of how much longer a particular campaign will last.

Additionally or alternatively, notification can be provided to notify the individual user 14 of the remaining duration of a campaign. For example, once the percentage-left statistic reaches a certain level, such as 5% left, for a media advertisement, a first notice, which may be in the form of an e-mail, is automatically sent out to the individual user 14 and to all other individual users who are currently running that media advertisement on their personal web pages and/or instant messages notifying them of the remaining life of the relevant campaign and of the fact that the particular campaign is about to end. The first notice can also notify the users that they may revisit the intermediary website 10 and switch to other media advertisements at anytime, that they may leave the media advertisement on their personal web pages and/or instant messages as long as they want (without receiving payment) even though the campaign is about to go inactive, and that they can contact the intermediary website 10 if they have any additional questions or concerns.

Once the campaign has ended, a second notice, which also may be in the form of an e-mail, is automatically sent to notify the individual user 14 that the campaign has ended, that the user may revisit the intermediary website 10 and switch to other media advertisements at anytime, that the user may continue to display the media advertisement as long as desired (without receiving payment) even though the campaign is inactive, and that the user can contact the intermediary website 10 if the user has any additional questions or concerns.

The user support website 16 may be configured to notify the individual user 14 of the services offered by the intermediary website 10.

As shown in FIG. 1, the intermediary website 10 and the user support website 16 are shown as separate sites. Instead, the intermediary website 10 may be a section within the user support website 16. In this latter case, the advertiser 12 places its media advertisements with the intermediary website section of the user support website 16, and the individual user 14 accesses this intermediary website section of the user support website 16 in order to select one or more media advertisements for display on the user's personal web page and/or instant message.

As a further alternative, instead of associating media advertisements with instant messages themselves, media advertisements can be associated with any mechanism utilized to send or support instant messages.

The individual user 14 can alternatively or additionally earn points in connection with placement of media advertisements on the user's personal web page. These points can be redeemable for cash, for a prize, or for some other non-cash award. The points are earned by the individual user 14 based on a specific action determined by the payment model chosen by the advertiser 12 for the particular media advertisement. For example, if a pay-per-click payment model is chosen, then each time a visitor clicks on the media advertisement located on or within the personal web page of the individual user 14, the individual user 14 earns a specified number of points instead of a straight cash payment. Once the individual user 14 earns a certain number of points, the individual user 14 can trade them in, such as but not limited to the intermediary website 10, for cash, for some form of prize, or for other non-cash award (e.g. TV, DVDs, movie tickets, posters, CDs, t-shirts, concert tickets, etc.).

As mentioned above, all revenues can be split between the individual user 14, the user support website 16, and/or the intermediary website 10. All payments received from the advertiser 12 by the intermediary website 10 can be electronically processed over the internet. Each time the advertiser 12 wishes to have a media advertisement placed on the intermediary website 10 to be accessible by the individual user 14, the advertiser 12 is required to have an electronic account with the intermediary website 10. This electronic account is set up so that every time the advertiser 12 owes money for a specific media advertisement and/or campaign, the specified amount will be charged or deducted from the electronic account of the advertiser 12. Alternatively, the account can be set up so that the advertiser 12 has to pay for the entire budget before the campaign is activated.

Payments to the individual user 14 for placing media advertisements of the advertiser 12 on the personal web page and/or instant messages of the individual user 14 can be electronically processed by the intermediary website 10 such as over the Internet. In order for the individual user 14 to receive payment for placing a media advertisement on the personal web page and/or instant messages of the individual user 14, the individual user 14 will need to create an electronic account with the intermediary website 10.

When the individual user 14 earns a cash payment from the media advertisement, the money is electronically deposited directly to an account, such as a bank account or other specified account, of the individual user 14. The individual user 14 also has the option to receive a paper check instead of electronic deposit.

Processing paper checks may be done electronically by the intermediary website 10. For example, each time the individual user 14 is to be paid by paper check, a separate electronic file is created by the intermediary website 10 with all of the information for the individual user 14 including name, address, and the total amount of payment. The file is electronically submitted by the intermediary website 10 to a bank. The bank processes the file and enters the check into its electronic system. That system then prints the paper checks and sends the checks, such as by mail, to the individual user 14. The intermediary website 10 can also act as a bank and print the paper check itself.

Cost-Per-Click (CPC) is an online advertising payment model in which payment is based only on the number of click-throughs that are generated. In Cost-Per-Click, the advertiser 12 is charged each time a visitor clicks on a media advertisement displayed on the personal web page of the individual user 14.

For example, a movie studio may want to promote a new film to the social networking and/or instant message communities. So, the movie studio, as the advertiser 12, places a poster of the film on the intermediary website 10 such that the poster contains a hyperlink, such as text or a graphic that can be clicked on with a mouse that leads to a website or page devoted at least partially to the film. The hyperlink is associated with a cost-per-click rate set by or for the movie studio. The individual user 14 visits the intermediary website 10, obtains the poster, and embeds the poster into the user's personal web page and/or instant messages. Thereafter, each time a visitor to the personal web page of the individual user 14 or a recipient of the user's instant messages clicks on the poster, the movie studio is charged at the cost-per-click rate that it set, or a deduction is made from the budget of the movie studio in the case where the movie studio pre-paid the budget.

Once the budget has been completely used up, the user support website 16, the intermediary website 10, and the individual user 14 displaying the poster will no longer receive payments when a visitor clicks on the poster. The individual user 14 is so notified and is allowed to keep the poster on the user's personal web page as long as desired without payment.

The revenues based on the cost-per-click rate is split between the individual user 14 and the intermediary website 10 and/or the user support website 16. Examples of media advertisements that warrant Cost-Per-Click include posters, pictures, graphics, music, movie trailers, music videos, commercials, games, animations, screen captures, etc.

Cost-per-thousand impressions (CPM) refers to the amount of money charged for one thousand impressions. For every 1,000 displays of a media advertisement, the advertiser 12 pays the specified CPM rate. If the media advertisement receives fewer then 1,000 impressions, or if the media advertisement receives more then 1,000 but fewer than the next increment of 1,000 views, the individual user 14 earns the percentage of impressions received. For example, if a media advertisement were to only receive 500 impressions, the individual user 14 would earn only 50% of the CPM rate. If a media advertisement were to receive 1,500 impressions, the individual user 14 would earn 150% of the CPM rate. Under this scenario the visitor, who visits the personal web page of the individual user 14 or who receives an instant message from the individual user 14, does not have to actually view (the ad is visible, but the visitor just chooses not to acknowledge it) or click on the media advertisement; all the internet user has to do is visit the web page or receive the instant message with which the media advertisement is associated and the visit will register as an impression. A number different that 1,000 can be used.

Examples of the types of media advertisements that warrant the CPM rate include wallpapers, posters, pictures, graphics, music, movie trailers, commercials, games, animations, and screen captures.

Flat rate refers to the payment of a flat fee for a media advertisement to appear on a personal web page or instant messages of the individual user 14 for a specified amount of time. If the individual user 14 removes the media advertisement before the specified amount of time has been reached, the individual user 14 earns a percentage based on the amount of time that the media advertisement did appear on the personal web page or instant messages. For example, if the advertiser 12 sets the amount of time at ten days for the flat rate campaign, but the individual user 14 removed the media advertisement after 5 days, the advertiser 12 would be charged 50% of the flat rate. On the other hand, if the individual user 14 keeps the media advertisement on the personal web page or instant messages for more then ten days, the advertiser 12 is not charged extra money and the intermediary website 10, the user support website 16, and the individual user 14 will earn no more payment for that media advertisement.

Examples of the types of media advertisements that warrant the flat rate include wallpapers, posters, pictures, graphics, music, movie trailers, commercials, animations, and screen captures.

Cost-per-play (CPP) means that every time a visitor plays a media advertisement associated with the personal web page or instant messages of the individual user 14, the advertiser 12 is charged the cost-per-play rate. This rate is useful with such media advertisements as videos and music. For example, a movie trailer is uploaded by the advertiser 12 to the intermediate website 10, and the individual user 14 obtains the trailer from the intermediate website 10 and embeds it into the user's personal web page. Each time a visitor watches or views the trailer, the advertiser 12 is charged the cost-per-play rate is set by the advertiser 12.

Examples of the types of media advertisements that warrant the CPP rate include videos, movie trailers, commercials, music videos, game trailers, video news, and sports highlights.

The only difference between the first version of the Cost-per-play (CPP) payment model described above and a second version of this model is that, in the first version, the media advertisement is on auto play, whereas in the second version the media advertisement is not on auto-play and will only start to play once a visitor clicks on the media advertisement. In other words, in the first version, when the visitor visits the personal web page of the individual user 14, the media advertisement starts playing automatically, and the advertiser 12 is immediately charged. But in the second version, when the visitor visits the personal web page of the individual user 14, the media advertisement does not play automatically. Instead, the media advertisement only plays when the Internet visitor clicks on it or a play button and, as a result, the media advertisement plays. Only then is the advertiser 12 is charged.

Examples of the types of media advertisements that warrant this second version of the CPP rate include videos, movie trailers, commercials, music videos, game trailers, video news, and sports highlights.

Cost-per-unique impression (CPUI) means that every time a different visitor visits the personal web page or a different person receives an instant message with a media advertisement on it the advertiser 12 is charged the cost-per-unique impression rate. The internet visitor does not have to actually view or click on the media advertisement for the advertiser 12 to incur a charge.

Examples of the types of media advertisements that warrant the CPUI rate include wallpapers, posters, pictures, graphics, music, movie trailers, commercials, games, animations, and screen captures.

Cost-per-action (CPA) means that every time an Internet visitor is directed to the website of the advertiser 12 or website chosen by the advertiser 12 by the media advertisement on the personal web page or instant messages of the individual user and then performs a desired action on the website of the advertiser 12 or website chosen by the advertiser 12, the advertiser 12 is charged the cost-per-action rate. Examples of actions include making a purchase, filling out a form, signing up for an account, viewing X number of pages, etc.

Examples of the types of media advertisements that warrant the CPA rate include movie trailers, video games media ads, commercials, posters, pictures, animations, and screen captures.

As described herein, the individual user 14 is able to choose a media advertisement from the intermediary website 10 or from the user support website 16, and then place that chosen media advertisement on the personal web page or instant messages of the individual user 14. The individual user 14 can also place the chosen media advertisement within professionally created content (e.g., TV show, movie, music), user generated content (e.g., videos, slide shows, pictures, etc.) or any other type of content that is or will be located on or within a personal web page or website. The chosen media advertisement may be assigned within the content by the intermediary website 10 so as to permit a visitor to the personal web page to select which of the media advertisements the visitor desires to view. Revenue is derived from this media advertisement as described above and is shared between the individual user 14, the user support website 16, and/or the intermediary website 10.

As described above, the advertiser 12 may place media advertisements on the intermediary website 10 or within a specified section of the user support website 16. The individual user 14 may select any offered one or ones of these media advertisements and (i) place the selected media advertisement directly on the user's personal web page or instant messages, (ii) assign the selected media advertisement to professionally created content (e.g., TV show, movie, music), user generated content (e.g., videos, slide shows, pictures, etc.), or any other type of content, or (iii) place the selected media advertisement in or on any other websites or Internet social networking systems over which the individual user 14 may have access or control. Each time the media advertisement is viewed and/or a specified action is taken in regard to the media advertisement by a visitor, advertising revenue is generated which is paid by the advertiser 12 to the intermediary website 10. The intermediary website 10 shares this revenue with the individual user 14 and/or the user support website 16.

As another alternative, a third party and/or the intermediary website 10 is allowed to assign multiple media advertisements to professionally created content, user generated content, or any other type of content that is or will be located on or within the personal web page, instant messages, or other websites which the individual user 14 has access to or controls. A visitor to the personal web page may select one or more of these media advertisements for viewing. Each time the media advertisement is viewed and/or a specified action is taken in regard to the media advertisement by the visitor, advertising revenue is generated which is paid by the advertiser 12 to the intermediary website 10. The intermediary website 10 shares this revenue with the individual user 14 and/or the user support website 16.

A series of strategies can be implemented by the intermediary website 10 to prevent fraud from occurring. There are various ways in which fraud can occur. For example, click fraud occurs in pay-per-click online advertising when a person, automated script, or computer program imitates a legitimate visitor clicking on an ad for the purpose of generating an improper charge per click.

Traffic fraud occurs in connection with cost-per-thousand impressions (CPM), cost-per-play (CPP), or cost-per-unique impression (CPUI) rates when a person, automated script, or computer program imitates a legitimate visitor by visiting a web page with a media advertisement on it for the purpose of generating an improper CPM, CPP, or CPUI charge.

Two main actions occur each time a media advertisement is viewed on the personal web page of the individual user 14 relative to the collection of information needed to prevent fraud. In one action, a media file is loaded into a player, which is used to display all forms of media advertisement. The media file contains not only the actual content of the media advertisement, such as video, image or music, but also a script. When the media advertisement is viewed, the script triggered by the media file collects the IP address, the operating system, the type of browser, and the screen resolution from the visitor who is viewing the media advertisement and stores this information in a database of the intermediary website 10. This information can be used to generate the unique ID discussed below. The script triggered by the media file also collects the time that the view occurred and the ID of the media advertisement and stores both in this database.

In the other action, an invisible tracking image is loaded under the player. The tracking image triggers a script that stores the IP address of the visitor and the HTTP Referrer, which records the URL of the site where the media advertisement was viewed, i.e., the IP address of the user support website 16.

All of the information that is gathered from the loading of the media file and by the invisible tracking image is then used by the intermediary website 10 according to four fraud detection tools in order to detect occurrences of fraud.

According to a first tool, the IP address that is gathered from the loading of the media file is verified against the IP address that is collected by the invisible tracking image to ensure that the IP addresses match. Fraudulent views and clicks are prevented because the script triggered by the invisible tracking image collects the IP address which must correlate to the IP address collected by the media file. If the two IP addresses do not match, the view is recorded as invalid.

Collecting the IP address twice at two different times allows the programming system within the intermediary website 10 to determine if an automated script, computer program or both is visiting the web page because these types of script and programs may attempt to bypass the tracking image or media file by directly accessing either the media file or invisible tracking image. This system ensures that both the media file and invisible tracking image are accessed by the same user.

In other words, the correlation of the two IP addresses ensures that the visitor viewing the media file is indeed viewing it directly from the website. It also allows us to correlate the HTTP Referrer of the visitor viewing the media file.

The media file is loaded when media is viewed, and the invisible tracking image is loaded with the player when a visitor visits a page containing the media.

According to a second tool, the programming system of the intermediary website 10 controls how long a media advertisement has to be viewed in order for it to be considered a valid view. For example, if the media advertisement is a video, the programming system of the intermediary website 10 counts a valid view only if at least 75% of the video is watched. If the visitor views less than 75% of the video, the view is recorded as invalid.

For a non-video media advertisement such as a picture or poster, the programming system of the intermediary website 10 sets a minimum amount of time that the non-video media advertisement has to be played or viewed for the play or view to be valid. If the non-video media advertisement is not played or viewed for that minimum amount of time, the play or view is counted as invalid.

This second tool also prevents automated scripts, computer programs or both from fraudulently counting plays or views because the TCP/IP connection that is initiated disconnects extremely fast. If the visitor's TCP/IP connection is not tracked for the minimum amount of time, the view is counted as invalid.

This second tool is also useful in preventing the posting of the media advertisement on pop-ups and pop-unders because pop-ups and pop-unders are typically unwanted, causing any user who receives the unwanted pop-ups and pop-unders to close them before the expiration of the minimum amount of time. So, if the media advertisement appears on a pop-up or pop-under, it is very unlikely that the Internet user experiencing the pop up or pop-under will view the media advertisement long enough for the view to register as valid view.

According to a third tool, the programming system of the intermediary website 10 uses the HTTP Referrer to validate the view and/or click. The HTTP Referrer signifies the URL of the personal web page that is asking for the filename in order to display the media advertisement. Once the individual user 14 has incorporated the media advertisement into the user's personal web page, a script is triggered each time the invisible tracking image is loaded. This script records the HTTP Referrer in the database of the intermediary website 10. If the correct HTTP Referrer does not get passed during the browser request for the invisible tracking image, the impression of the media advertisement will not be counted as a valid impression.

When the individual user 14 registers for an account with the intermediary website 10, the individual user 14 has to enter the URL of its user support website 16 on which the media advertisement selected by the individual user 14 will appear. Each time there is a request for the filename of the media advertisement, the HTTP Referrer is verified against the URL that was entered by the individual user 14 during the signup processes. If the two URLs do not sufficiently correlate, then the view or the click is not considered valid.

This third tool prevents the individual user 14 from earning money by placing media advertisements on multiple web pages.

According to a fourth tool, a unique ID is created twice by the player that displays the media advertisement and is utilized to detect fraud. For example, the unique ID is generated when the media advertisement is first viewed, and the unique ID is passed with the click when the media advertisement is first clicked on. Each click passes the unique ID that was created with the view.

Each time a legitimate visitor accesses the personal web page of the individual user 14 so that the visitor is enabled to view the media advertisement, the player generates a unique ID for that particular access (view) and stores it. When the same visitor then first clicks on the media advertisement to view the linked video, poster, picture, graphic, music, commercial, game, animation, screen capture, etc., the player passes the exact same unique ID and stores it. The programming system of the intermediary website 10 verifies that the unique ID from the access (view) matches the unique ID from the click. If the numbers do not match, the view is marked as invalid.

This fourth tool prevents automated scripts, program systems, or both from imitating a legitimate visitor clicking on an ad. For example, when an attempt is made to create fraudulent clicks, the click-through URL, i.e., the URL that takes a visitor to the website of the advertiser 12 once the media advertisement is clicked on, is copied and pasted into an automated system that continuously sends IP addresses through that URL, thus simulating clicks on the media advertisement. This fourth tool stops these clicks from being registered as valid because the unique ID for each click is only valid when it matches the same exact unique ID from the view and is valid for only one click. So, the unique ID of the click would already be expired such that a second attempt to use the same unique ID will be recorded as invalid.

The programming system of the intermediary website 10 offers the advertiser 12 the ability to broadcast live through players that are already running media advertisements on the personal web page of the individual user 14.

For example, if the advertiser 12 wants to advertise a movie, the advertiser 12 can broadcast a live video advertisement, such as an actor from the movie talking about the movie, directly through any player (such as one provided by the intermediary website 10) that is embedded into the personal web page of the individual user 14. So, any visitor to that personal web page at the same time the live broadcast is taking place can view the live video advertisement through the personal web page.

In other words, the programming system of the intermediary website 10 allows a live video feed to occur at any time through players that have already been embedded into the personal web page of the individual user 14. So, if the intermediary website 10 has 1,000 individual users that have embedded any type of advertisement in their personal web pages, the advertiser 12 can broadcast its live advertisement on all 1,000 players. Or, the programming system of the intermediary website 10 can instead allow the intermediary website 10 to select a subset of the players currently running media advertisements to receive the live broadcast.

For example, 1,000 individual users may have various media advertisements running from different video campaigns on their personal web pages and, of those 1,000 individual users, only 100 are running a media advertisement associated with a particular movie produced by the advertiser 12. The intermediary website 10 can offer the advertiser 12 the opportunity to broadcast its live advertisement for that movie to only the 100 video players corresponding to media advertisement associated with the particular movie.

The advertiser 12 is charged a flat fee, a cost-per-click, cost-per-play, cost-per-unique impression, or cost-per-thousand impressions rate as appropriate for this service.

The operator of the intermediary website 10 need not attach the media advertisements to other content. Thus, the media advertisements can be stand alone media advertisements posted on the intermediary website 10. Accordingly, the individual user 14 who sets up a personal web page on the user support website 16 is not required to download other content in order to embed the media advertisements into the user's web page or blog, and the advertiser 12 has the assurance that its media advertisements are not encumbered by content that may obscure their media advertisements.

Alternatively, as described herein, the individual user 14 has the option of placing one or more media advertisements selected from the intermediary website 10 within professionally created content (e.g., TV show, movie, music), user generated content (e.g., videos, slide shows, pictures, etc.) or any other type of content that is or will be located on or within a personal web page or website.

Advertisers pay for the services of the intermediary website 10 and for the individual user 14 to include media advertisements on the user's personal web page or in the user's instant messages. For example, advertisers can be required to pay on a cost-per-click basis such that advertisers will pay for each click or for each number of clicks on the media advertisements posted on the personal web pages, on various cost per play bases, on a cost per number x (such as one thousand) impressions basis, on a cost per unique impression, on a flat rate basis, or on any other basis. The revenues can be shared between the individual users who set up personal web pages, the operators of the social networking and blog communities, and/or the operator of the intermediary website.

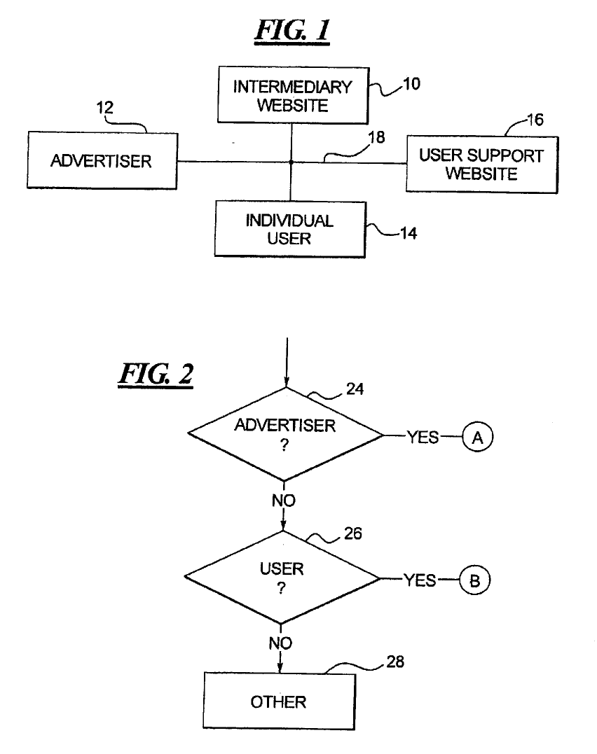

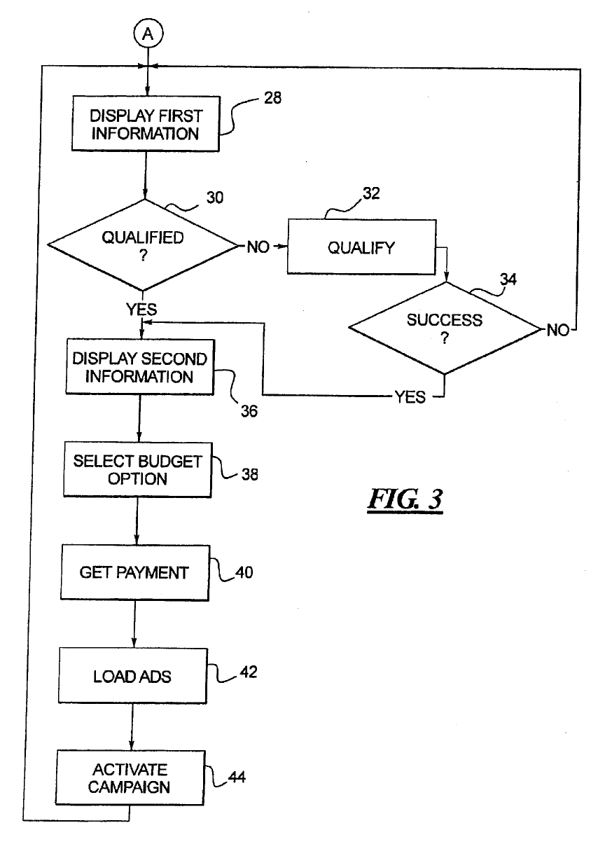

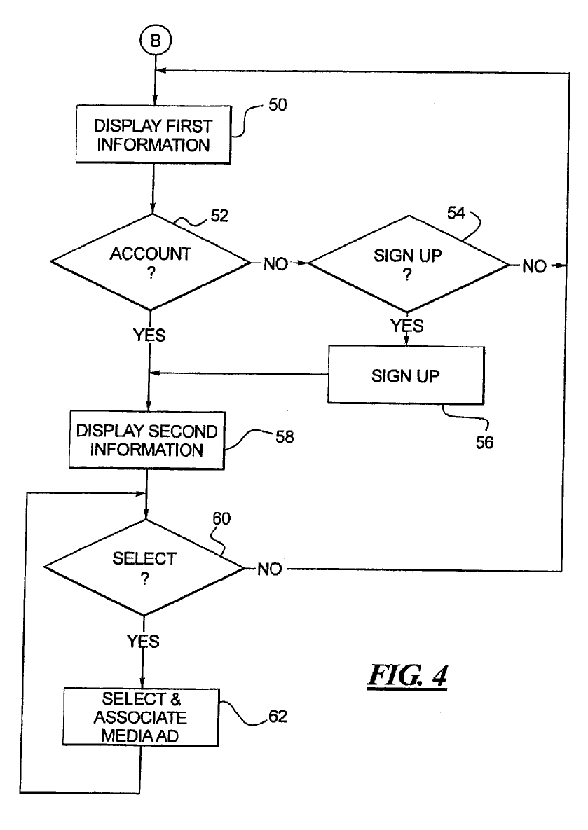

FIGS. 2, 3, 4, 5, 6A, 6B, and 7 are flow charts of operations that are implemented by the intermediary website 10 through use of its computer or computers. As shown by the flow chart of FIG. 2, the intermediary website 10 determines at 24 whether the advertiser 12 has accessed the intermediary website 10 over the communications medium 18. If so, flow proceeds to FIG. 3. If not, the intermediary website 10 determines at 24 whether the individual user 14 has accessed the intermediary website 10 over the communications medium 18. If so, flow proceeds to FIG. 4. If not, the intermediary website 10 determines at 26 that someone else has accessed the intermediary website 10 over the communications medium 18, in which case the intermediary website 10 appropriately performs other processing.

Assuming that the advertiser 12 has accessed the intermediary website 10, the intermediary website 10 at 28 displays appropriate information to the advertiser 12 such as information about the services that are offered to advertisers by the intermediary website 10, a next button to move onto the next screen, etc.

After 28, the intermediary website 10 determines at 30 whether the advertiser 12 has previously qualified for an account with the intermediary website 10. For example, the intermediary website 10 may determine that the advertiser 12 is qualified if the advertiser 12 is simply able to log on to the intermediary website 10 at this point.

If the intermediary website 10 determines at 30 that the advertiser 12 has not previously qualified for an account with the intermediary website 10, the intermediary website 10 at 32 offers an opportunity for the advertiser 12 to qualify for an account with the intermediary website 10 and processes a qualification request if the advertiser 12 chooses to qualify for an account with the intermediary website 10.

If, as determined at 34, the advertiser 12 chooses not to qualify for an account with the intermediary website 10 or fails to qualify for an account with the intermediary website 10, an exit screen can be presented to the advertiser 12 as desired and flow returns to 28.

However, if it is determined at 34 that the advertiser 12 chooses to qualify for an account with the intermediary website 10 and does in fact qualify for an account with the intermediary website 10, additional information is displayed to the advertiser 12 at 36. This additional information, for example, may include information on various budget and payment options selectable by the advertiser 12 and other information that enables the advertiser 12 to take advantage of the services offered by the intermediary website 10.

At 38, budget and payment options are offered to the advertiser 12 and the advertiser 12 is prompted to select an appropriate option. If the intermediary website 10 or the advertiser 12 selects an option requiring an up front payment, the payment is collected at 40. The payment may be collected by various arrangements. For example, payment may be collected electronically by use of the communications medium 18. Alternatively, payment could be collected by means other than over the communications medium 18.

After payment arrangements are made at 40, the advertiser 12 is prompted at 42 to load media advertisements onto the computer or computers of the intermediary website 10. Once the media advertisements are loaded at 42, the intermediary website 10 activates the media campaign at 44. The functions of 40 and 42 could be performed in reverse order.

Assuming that the individual user 14 has accessed the intermediary website 10 as determined at 26 of FIG. 2, the intermediary website 10 at 50 of FIG. 4 displays appropriate information to the individual user 14. For example, the individual user 14 may be presented with information about receiving payment for associating media advertisements with the user's personal web page. The individual user 14 may be allowed to browse available media advertisements and to play any of these media advertisements.

After 50, the intermediary website 10 determines at 52 whether the individual user 14 has previously established an account with the intermediary website 10. For example, the intermediary website 10 may determine that the individual user 14 has an account if the individual user 14 is simply able to log on to the intermediary website 10 at this point.

If the intermediary website 10 determines at 52 that the individual user 14 does not have an account with the intermediary website 10, the intermediary website 10 at 54 offers an opportunity for the individual user 14 to sign up for an account. If, as determined at 54, the individual user 14 chooses not to sign up for an account with the intermediary website 10, an exit screen can be presented to the individual user 14 as desired and flow returns to 50.

If, as determined at 54, the individual user 14 chooses to sign up for an account with the intermediary website 10, the intermediary website 10 processes the sign up operations at 56. If the individual user 14 previously signed up for an account as determined as 52, or after the individual user 14 signs up for an account with the intermediary website 10 at 56, additional information is displayed to the individual user 14 at 58. This additional information, for example, may include the media advertisements, payment related information such as the amount and types of payments that are to be made to the individual user 14 for each corresponding media advertisement, and percentage left as discussed above. The individual user 14 is also prompted to select media advertisements.

If the individual user 14 makes a selection as determined at 60, the individual user 14 is prompted at 62 to associate the selected media advertisement with the user's personal web page or instant messages in any manner described above. Thereafter, flow returns to 60 where the individual user 14 can make additional selections, if desired. When the individual user 14 is done making selections as determined at 60, flow returns to 50.

As shown in FIG. 5, the intermediary website 10 at 70 tracks revenue generating activities with respect to the personal web page and/or instant messages of the individual user 14, at 72 pays out revenues at the appropriate times, and at 74 sends out notices at the appropriate times. Alternatively, instead of the intermediary website 10 tracking these revenue generating activities, revenue generating activities can be tracked any other party.

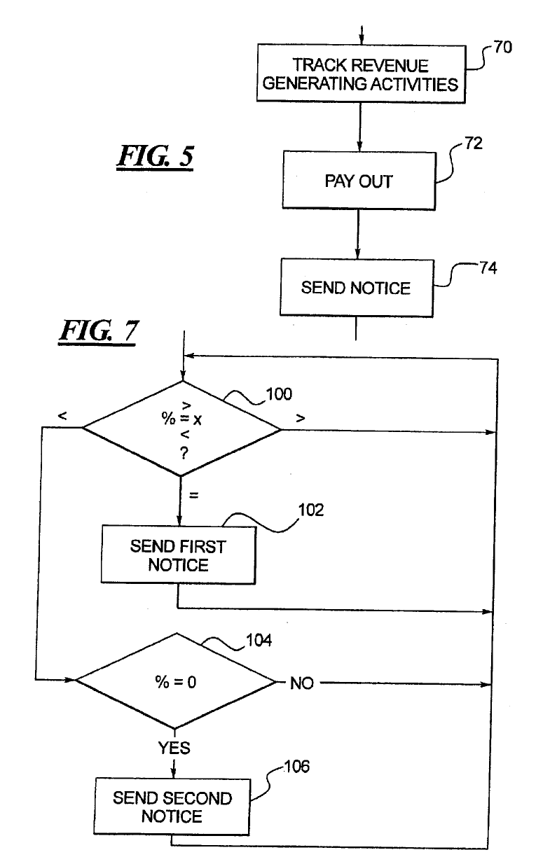

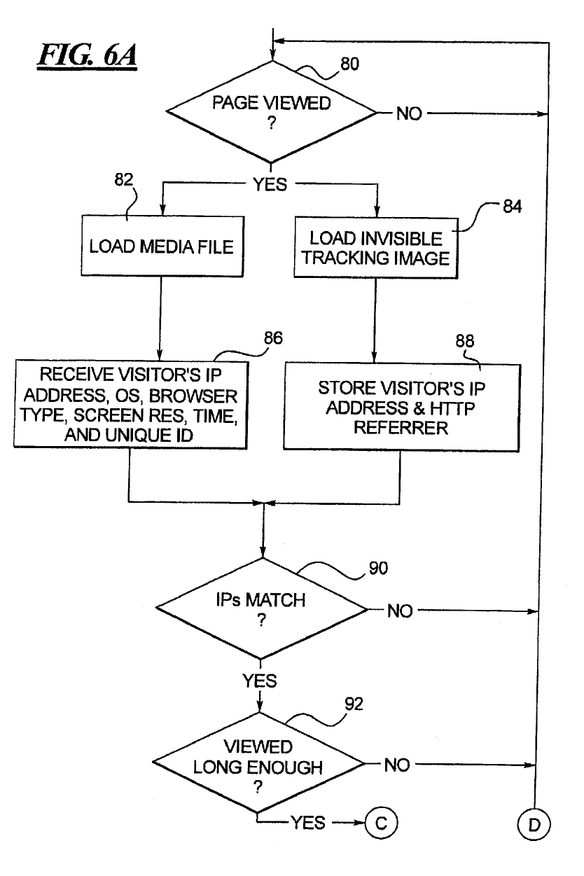

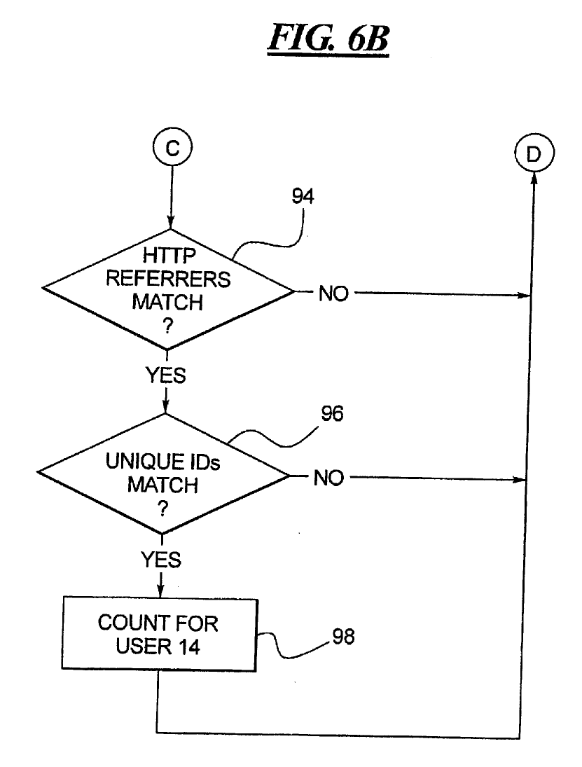

Tracking at 70 is shown more fully in connection with FIGS. 6A and 6B, and notice sending at 74 is shown more fully in connection with FIG. 7.

The payment function at 72 may be the electronic transfer of cash or non-cash payments to the individual user 14 and/or to the user support website 16 or the transfer of sufficient information to other institutions that these other institutions can make the actual cash or non-cash payments. In these cases, the transfers may be made at 72 over the communications medium 18. Alternatively, the transfers may be made at 72 using other means such as a postal service or other physical transfer service.

As shown in FIGS. 6A and 6B, when a personal page of the individual user 14 is viewed by a visitor as determined at 80, the intermediary website 10 at 82 loads the media file and at 84 loads the invisible tracking image all as discussed above. As a result, the intermediary website 10 at 86 receives and stores the visitor's IP address, time, and/or unique ID, and the intermediary website 10 at 88 receives and stores the visitor's IP address (again), the HTTP Referral (the URL of the user support website 16 that supports the personal web page or instant messages of the individual user 14, and the unique ID.

At 90 after 86 and 88, the intermediary website 10 invokes the first fraud detecting tool described above. At 92, the intermediary website 10 invokes the second fraud detecting tool described above. At 94, the intermediary website 10 invokes the third fraud detecting tool described above. At 96, the intermediary website 10 invokes the fourth fraud detecting tool described above. These tools may be invoked serially or in parallel. (Indeed, all of the functions shown in FIGS. 2, 3, 4, 5, 6A, 6B, 7, and 8 may be invoked serially or in parallel.) If the monitored activity passes the test imposed by each of these tools, the intermediary website 10 at 98 counts the activity as a valid revenue generating activity. However, if the monitored activity fails to pass any one of the tests imposed by these tools, the intermediary website 10 rejects the activity as an invalid revenue generating activity and does not base any revenue on this activity.

Even though the processing at 80 through 88 can be arranged to run continuously, the processing at 90-98 may be performed on a periodic basis, such as once every ten minutes and/or once per view, and verified at pay out time.

As mentioned above, the notice sending at 74 is shown more fully in connection with FIG. 7. If the percentage left as determined at 100 is greater than a threshold x (e.g., 5%), the intermediary website 10 sends no notice to the individual user 14. Alternatively, the intermediary website 10 in this event could instead be arranged to send notices to the individual user 14 of general interest. In either case, flow returns to 100.

If the percentage left as determined at 100 is equal to the threshold x, the intermediary website 10 at 102 sends the first notice described above to the individual user 14. Thereafter, flow returns to 100.

If the percentage left as determined at 100 is less than the threshold x, the intermediary website 10 determines at 104 whether the percentage left is equal to zero. If the intermediary website 10 determines at 104 that the percentage left is not equal to zero, the intermediary website 10 sends no notice to the individual user 14. Alternatively, the intermediary website 10 in this event could instead be arranged to send notices to the individual user 14 of general interest. Thereafter, flow returns to 100.

If the percentage left as determined at 104 is equal to zero, the intermediary website 10 at 106 sends the second notice described above to the individual user 14. Thereafter, flow returns to 100.

FIG. 8 is a flow chart of the operations that are implemented by the individual user 14 through use of one or more computers and that are pertinent to the present invention. As shown by the flow chart of FIG. 8, the individual user 14 at 110 accesses the intermediary website 10 and at 112 views information provided by the intermediary website 10. This information is the information displayed by the intermediary website at 50.

If the individual user 14 has not previously established an account with the intermediary website 10, the individual user 14 may choose at 114 to sign up for an account with the intermediary website 10. On the other hand, if this access to the intermediary website 10 is not the first access by the individual user 14 of the intermediary website 10, the individual user 14 may instead simply choose at 114 to log on to the intermediary website 10. Alternatively, the individual user 14 may choose neither option at 114, in which case flow returns to 110.

If the individual user 14 chooses at 114 to sign up for an account with the intermediary website 10, the sign up process is performed at 116. If the sign up process is not successful as determined at 118, flow returns to 110. If the sign up process is successful as determined at 118, or if the individual user 14 chooses at 114 to log on to the intermediary website 10, the individual user 14 is provided additional information at 120. This additional information is the information displayed by the intermediary website at 58.

Thereafter, the individual user 14 at 122 provides the URL of the individual user's personal web page and at 124 is able to select media advertisements or view the percentage left. If the individual user 14 wishes to merely view the percentage left and/or the type of payment model and/or how much is being paid out, the individual user 14 performs the view at 126, after which flow returns to 110. If the individual user 14 instead selects media advertisements at 124, at 128 the selected media advertisements are associated with the user's personal web page or instant messages. Alternatively, the individual user 14 may elect at 124 to both view the percentage left and/or the type of payment model and/or how much is being paid out and to select media advertisements.

Thereafter, flow returns to 110. Alternatively, as shown in FIG. 8, the individual user 14 at 130 may electronically receive any payment that is due.

As an additional feature, the individual user 14 who has created a personal web page as described above can attach a video to an advertisement displayed on the personal web page. The video can be recorded of any subject. For example, the video can relate to the advertisement. In this case, the video might encourage the visitor to view the advertisement and/or to seek out additional information about the subject matter, such as a product, of the advertisement. Additionally or alternatively, the video can be a personal video recorded of the individual user 14 relating to any subject such as the advertisement, etc. Still additionally or alternatively, the video may be a pre-recorded video relating to the individual user 14 and/or to the advertisement and/or to any other subject.

The video may be linked to any type of advertisement, whether a media advertisement or otherwise.

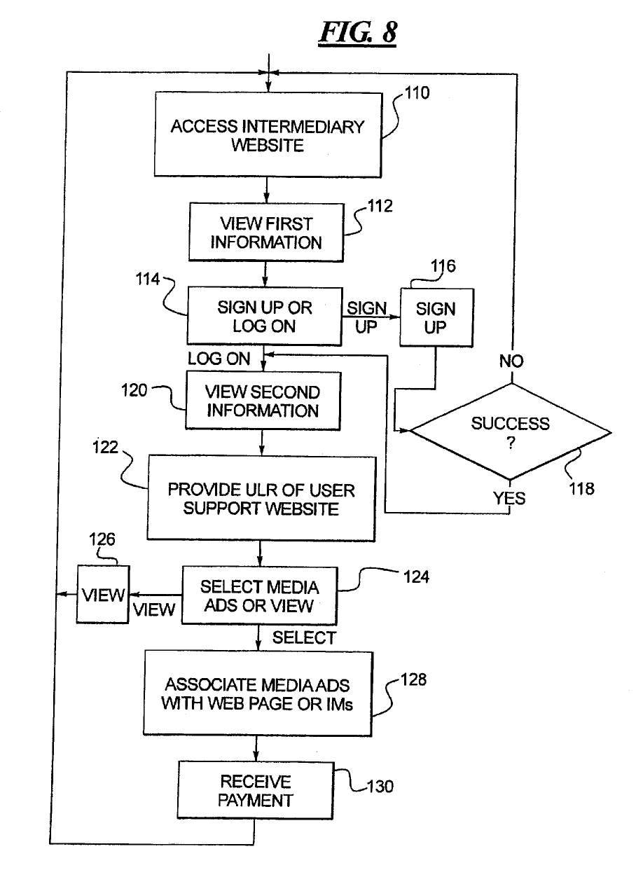

The visitor who views the personal web page of the individual user 14 can see from an advertisement that a video has been added to it. For example, FIG. 9 shows an advertisement 150 on a personal web page before a video has been added to it. FIG. 10 shows the advertisement 150 on the personal web page after a video has been is added to it. In this case, a video notifier 152 appears on the personal web page of the individual user 14 in close association to the advertisement 150 to notify a visitor that a video has been added to advertisement 150. If the video has been added to the advertisement 150 so that the video plays before the advertisement 150, the video notifier 152 can be placed at the beginning of the advertisement 150 as shown in FIG. 10. Thus, when the visitor to the personal web page views the advertisement 150, the video plays before the advertisement 150.

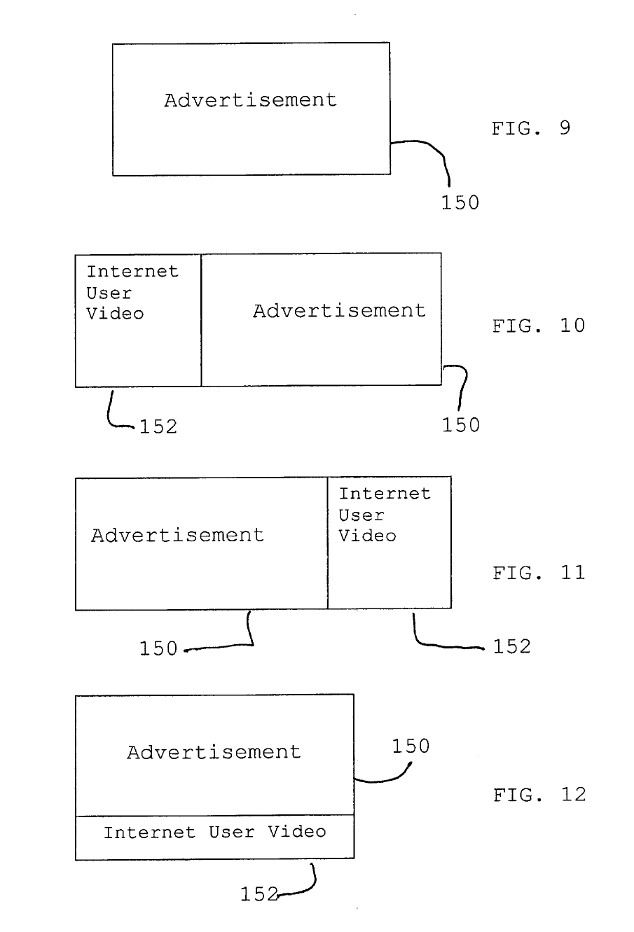

FIG. 11 alternatively shows placement of the video notifier 152 when the associated video is to play after the advertisement 150. Thus, if the video has been added to the advertisement 150 so that the video plays after the advertisement 150, the video notifier 152 can appear at the end of the advertisement 150. Thus, when the visitor to the personal web page views the advertisement 150, the advertisement 150 plays before the video.

FIG. 12 shows a further alternative in which the video notifier 152 is not displayed to the visitor until the visitor plays the advertisement 150. In this case, the video notifier 152 appears on the screen as the advertisement 150 plays. Alternatively, the video notifier 152 can be made to appear on the screen as the advertisement 150 first begins to play or at the end of the play of the advertisement 150. If the visitor wants to see the video, the visitor clicks on the video notifier 152 to view the video.

The video notifier 152 may be an enclosed shape such as the box as shown in FIGS. 9-12. Alternatively, the video notifier 152 may be a word, a change in appearance, or any other mechanism that conveys the idea that video has been added to an advertisement.

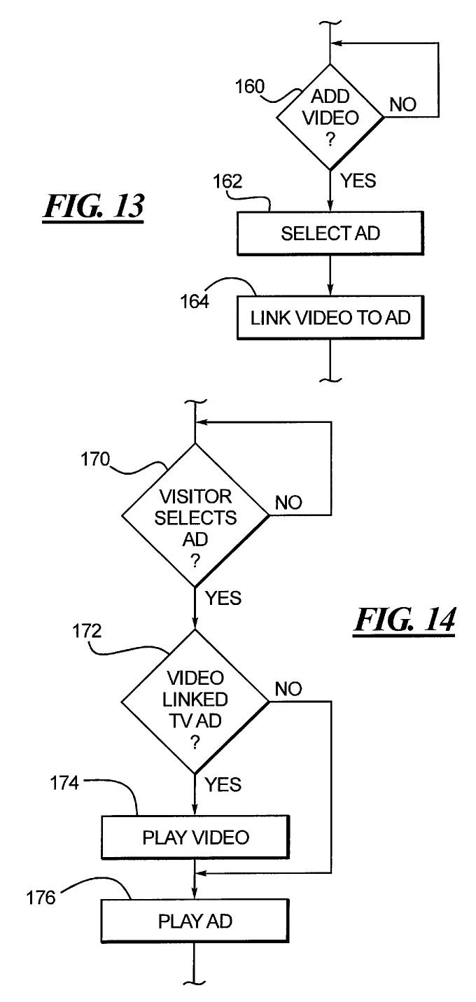

FIG. 13 is a flow chart of the operations that are implemented by the individual user 14 through use of one or more computers to add video to an advertisement appearing on the personal web page of the individual user 14. If the individual user 14 chooses to add a video to an advertisement as determined at 160, the individual user 14 at 162 selects the advertisement to which the video is to be added, and at 164 adds the video to the selected advertisement.

The video notifier 152 may be any type of link between the advertisement and the video or between the video notifier 152 and the video such that, when the visitor clicks on the video notifier 152 or simply chooses to play the video or otherwise, the link is activated to play the video at the appropriate time. The video can be hosted anywhere such as at the individual user 14 or at a remote web site. In this latter case, the link may be a hyperlink.

FIG. 14 is a flow chart of additional operations that are implemented by the individual user 14 through use of one or more computers to play the video associated with an advertisement appearing on the personal web page of the individual user 14. If the visitor to the personal web page of the individual user 14 selects an advertisement on that personal web page as determined at 170, and if video is linked to the selected advertisement or the video notifier associated with the selected advertisement as determined at 172, the video is played at 174 and the advertisement is played at 176. However, as discussed above, the order of 174 and 176 may be reversed, or the video may be played only if the visitor clicks on the selected advertisement. Other alternatives are possible.

On the other hand, if the visitor to the personal web page of the individual user 14 selects an advertisement on that personal web page as determined at 170, and if video is not linked to the selected advertisement or to the video notifier associated with the selected advertisement as determined at 172, then only the advertisement is played.

Additionally or alternatively, instead of playing the video dependent upon some action of the visitor such as selecting the advertisement to which the video has been added or clicking on the video notifier, the advertisement and the video may simply start playing in any order when the advertisement first appears in a part of the personal web page visible to the visitor or when the personal web page first loads.

The video added to an advertisement may be recorded by the individual user 14 or by another.

Although the above discussion relates specifically the association of videos to advertisements, videos can be associated with instant messages and/or the like.

Certain modifications of the present invention have been discussed above. Other modifications will occur to those practicing in the art of the present invention. For example, the advertiser 12 can be, for example, the entity whose goods or services are being advertised by the media advertisements. Alternatively, the advertiser 12 might be an agency that creates advertisements and/or that places advertisements in selected spots.

Also, FIG. 1 shows only one advertiser, one individual user, and one user support website. However, it should be understood that the blocks 12, 14, and 16 of FIG. 1 actually represent multiple advertisers, multiple individual users, and/or multiple user support websites.

Moreover, tracking of revenue generating activities is described above as being performed by the intermediary website 10. However, some or all of the revenue generating activities may be tracked by a site other than the intermediary website 10, such as a website that is independent of the intermediary website 10, the advertiser 12, the individual user 14, and the user support website 16.

Furthermore, as described above, the individual user is prompted to associate a selected media advertisement with the user's personal web page or instant messages. However, the individual user may simply choose which media advertisement is to be associates with the user's personal web page or instant messages and the actual association of the chosen media advertisement with the user's personal web page or instant messages is performed by another party, such as by the user support website 16.

In addition, four tools have been described above to detect occurrences of fraud. Additional or alternative fraud detection tools can be used. For example, the position of the mouse can be checked to make sure that it corresponds to each click. Thus, automated clicks such as those generated by Javascript can be detected.

Also, as described above, the personal webpage of the individual user 14 is hosted by the user support website 16, which can, for example, be a social networking website or a blog. Instead, the personal webpage of the individual user 14 can be hosted by the intermediary website 10.

Moreover, the term “personal web page” has been used above to describe the personal space of the individual user to which a media advertisement chosen by the individual user may be associated. However, the present invention may be used in connection with other personal spaces such as virtual spaces, mobile devices, and any other form of electronic representation of the user's personal space.

Furthermore, as described above, some or all of the functions of the intermediary website 10 can be performed by the user support website 16. Alternatively, some or all of the functions of the user support website 16 can be performed by the intermediary website 10.

The functions shown in FIGS. 2, 3, 4, 5, 6A, 6B, 7, and 8 may be performed in an order that is different from that shown.

The linking of a video to an advertisement has been described above in the context of a first party's personal web page that is hosted by a second party, where the first party, for example, may be an individual user and the second party, for example, may be a social networking website. However, the advertisement to which a video may be linked may instead be hosted on a personal space, and the personal space, for example, may be a virtual space, a mobile device, a website, or any other form of electronic representation operated by the individual user or by a company or by a blog or otherwise. Moreover, this personal space may be a website hosted on the user's own computer

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

I claim:

1. A method performed by a web accessible computer comprising:
providing an advertisement as an element of a personal space of a user;
adding a video to the advertisement;
playing the video in relation to the advertisement.

2. The method of claim 1 wherein the user comprises a first party, wherein the personal space is provided by a second party, and wherein the first and second parties are different parties.

3. The method of claim 2 wherein the first party comprises an individual user, and wherein the second party comprises a social networking provider.

4. The method of claim 2 wherein the first and second parties are remotely located from one another and communicate with one another by way of the Internet.

5. The method of claim 2 wherein the personal space comprises a personal web page, and wherein the second party comprises a social networking provider hosting the personal web page.

6. The method of claim 2 wherein the second party comprises a blog website.

7. The method of claim 1 wherein the user comprises a first party, wherein the playing of the video comprises playing the video in response to an electronic access by a second party, and wherein the first and second parties are different parties.

8. The method of claim 7 wherein the first and second parties are remotely located from one another and communicate with one another by way of the Internet.

9. The method of claim 1 wherein the playing of the video comprises:
first playing the video; and,
subsequently playing the advertisement.

10. The method of claim 1 wherein the playing of the video comprises:
first playing the advertisement; and,
subsequently playing the video.

11. The method of claim 1 wherein the user comprises a first party, wherein the adding of a video to the advertisement comprises associating a video notifier with the advertisement, wherein the video notifier is arranged to notify a second party that the video is linked to the advertisement, and wherein the first and second parties are different parties.

12. The method of claim 11 wherein the playing of the video comprises playing the video in response to an electronic access by the second party.

13. The method of claim 12 wherein the first and second parties are remotely located from one another and communicate with one another by way of the Internet.

14. The method of claim 12 wherein the playing of the video comprises:
first playing the video; and,
subsequently playing the advertisement.

15. The method of claim 12 wherein the playing of the video comprises:
first playing the advertisement; and,
subsequently playing the video.

16. The method of claim 12 wherein the playing of the video comprises playing the advertisement, wherein the method further comprises displaying the video notifier in response to the playing of the advertisement, and wherein the playing of the video further comprises playing the video in response to selection of the video notifier.

17. The method of claim 12 wherein the playing of the video further comprises playing the video in response to selection of the video notifier.

18. The method of claim 1 wherein the video comprises a video concerning subject matter of the advertisement.

19. The method of claim 1 wherein the video comprises a video created by the user.

20. The method of claim 1 wherein the user comprises a first party, wherein the video comprises a video created by a second party, and wherein the first and second parties are different parties.
